(19) United States
(12) Patent Application Publication
(10) Pub. No.: US 2002/0107659 A1
(43) Pub. Date: Aug. 8, 2002

(54) Orientation and position sensor

(76) Inventor: Charles S. Vann, Burlingame, CA (US)

Correspondence Address: Charles S. Vann, 1425 Drake Avenue, Burlingame, CA, 94010, US

(21) Appl. No.: 09/893,952

(22) Filed: Jun. 28, 2001

Related U.S. Application Data
(63) Continuation-in-part of application No. 09/777,962, filed on Feb. 5, 2001.

(51) Int. Cl. G01C 9/00; G06F 15/00; G01C 17/00; G01C 19/00

(52) U.S. Cl. 702/150

(57) ABSTRACT

The Orientation and Position Sensor is a compact, non-contact sensor that measures up to three orientations and up to three positions of an alignment target with respect to a camera. The alignment target has two distinct features, and a lens images those features into a camera. From the camera image, an operator or software can interpret the relative position and size of the features to determine the orientation and position of the alignment target with respect to the camera.

### CROSS-REFERENCE TO RELATED APPLICATIONS

This application is related to application Ser. No. 09/777,962, filed Feb. 02, 2001 titled Orientation and Position Sensor

### BACKGROUND

1. Field of Invention

This invention relates to multi-dimensional orientation and position sensors. This sensor detects up to three-dimensional position, i.e. the distance of an object relative to three orthogonal axes of a reference frame. Also, it measures orientation of that object about each of the three axes of that reference frame.

### BACKGROUND

2. Description of Prior Art

Many types of sensors measure position or orientation on an object relative to a sensor. However, most measure only one position or one orientation of the possible six: three-dimensions of position and three-dimensions of orientations. A few sensors measure two or three dimensions, but cost and complexity increase greatly with an increase in the number measured. A typical three-dimensional position sensor commonly used for measuring accuracy of construction can cost as much as one quarter of a million dollars and provide no information on orientation. Of course, six or more one-dimensional position sensors can be located around an object such that an object's position and orientation can be determined. However, this also is a costly and complex approach with another disadvantage of a workspace that is large and highly susceptible to misalignment.

There are some sensors that measure all three orientations and all three positions, such as the “Polhemus”. While it is a relatively compact sensor, it has a distinct disadvantage of requiring a metallic target and falters when any additional metal is in the workspace. Since there are usually many metal objects in the workplace, this sensor has very limited application. The most common type of tracking systems use multiple cameras such as the “ReActor”, observing an object from many different angles. While such a system can track all the orientations and positions of an object, it is computationally intensive and only applicable when a large space is available to mount cameras at different fields of view. Furthermore, multiple sensors are very vulnerable to misalignment, since motion of any of the sensors due to temperature, structural creep, or accidental disturbance will un-calibrate the system.

### SUMMARY

In accordance with the present invention, all orientations and positions are detected with a single sensor, simply and at low cost. The object is tagged with a small, inexpensive alignment target. Unlike the “Polhemus” sensor, this invention works in a metallic surrounding, and unlike “ReActor” it has only one camera.

### OBJECTS AND ADVANTAGES

Accordingly, several objects and advantages of my invention are:

Reliably measures all three positions and three orientations with one sensor.

Very small size, allows use in space-restricted places other sensors cannot.

As an optical sensor, it does not contact or interfere with object it is sensing.

High-speed operation of many detections/second, enabling it to track objects.

Simple and low-cost, consisting of a camera, optics, target, and monitor.

Capable of sub-millimeter position and sub-milliradian orientation accuracy.

Further objects and advantages of my invention will become apparent from a consideration of the drawings and ensuing description.

### DRAWING FIGURES

Reference is now made to the embodiment of Orientation and Position Sensor illustrated in FIG. 1-6 wherein like numerals are used to designate like parts throughout.

FIG. 1 is an isometric view of first embodiment of sensor.

FIG. 2 is a camera image of alignment target in reference position and orientation.

FIG. 3 is a camera image of alignment target deviating from reference image.

FIG. 4 is an isometric view of second embodiment of sensor.

FIG. 5 is an isometric view of third embodiment of sensor.

FIG. 6 is an isometric view of forth embodiment of sensor.

### REFERENCE NUMERALS IN DRAWING

10 first embodiment

11 alignment target

12 camera

13 lens

14 optical axis of lens

15 camera cable

16 monitor

21 spot

22 base

23 transparent support

24 cross-hair

24a-c cross-hair strands

25 XYZ reference frame

30 camera image

31 center of camera image

40 second embodiment

41 posts

50 third embodiment

60 forth embodiment

61 computer

### DESCRIPTION

### First Embodiment

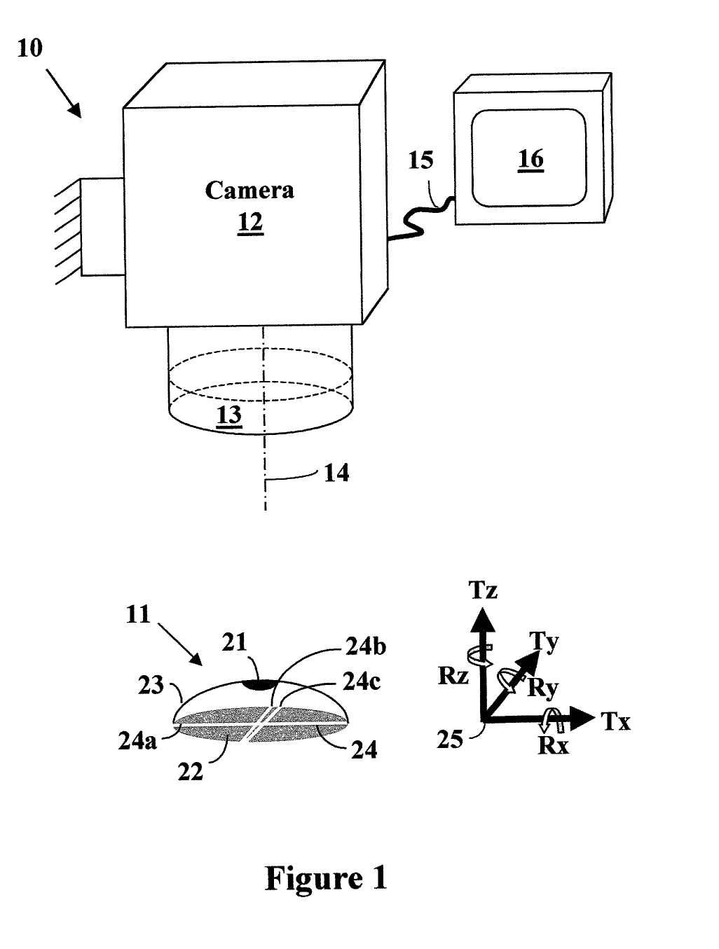

FIG. 1 shows the first embodiment of Orientation and Position Sensor 10 including alignment target 11, camera 12, lens 13 with optical axis 14, cable 15, and monitor 16. In a preferred arrangement, alignment target 11 includes a spot (first-feature) 21, base 22, transparent support 23, and a cross-hair (second-feature) 24. Spot 21 is circular, opaque, and mounted onto transparent support 23. Transparent support 23 is mounted on base 22. Base 22 is opaque and cross-hair 24 is drawn, attached, scribed or by other means highlighted on base 22. Cross-hair 24 may consist of several strands, e.g. 24a-c, that in the preferred embodiment are placed in a non-symmetric arrangement to avoid orientation ambiguity.

Also shown in FIG. 1 is a reference frame 25 with three orthogonal axes (XYZ) to describe translation (TX, Ty, Tz) and orientation (Rx, Ry, Rz) errors.

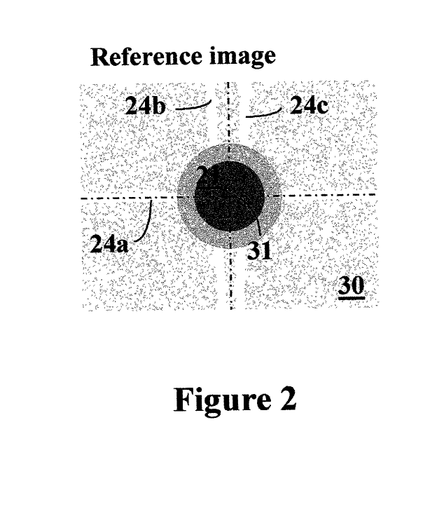

FIG. 2 shows camera image 30 of alignment target 11.

### Operation

Alignment target 11 is placed in the field of view of camera 12 such that camera image 30 contains first and second features 21,24. The relative size and location of those features will be compared to the image 30 of a target 11 perfectly aligned to camera 12.

FIG. 2 shows camera image 30 when alignment target 11 is perfectly aligned with camera 12. This image is referred to hereafter as reference image 30, and the location of features 21,24 are described as right/left or up/down relative to image center 31 in the horizontal and vertical direction, respectively.

In reference image 30, features 21,24 are symmetric about camera center 31, and strand 24a is parallel with horizontal of image 30, and spot 21 is at the preset diameter as described below.

In the preferred reference image 30, cross-hair 24 is in focus, but spot 21 is not in focus. Out of focus, spot 21 is blurred, and the diameter of the blur varies linearly and sensitively to the distance between alignment target 11 and camera 12, i.e. translation along the Z axis. Therefore, establishing a preset diameter of spot 21 defines a distance between alignment target 11 and camera 12 as the Z-axis reference position.

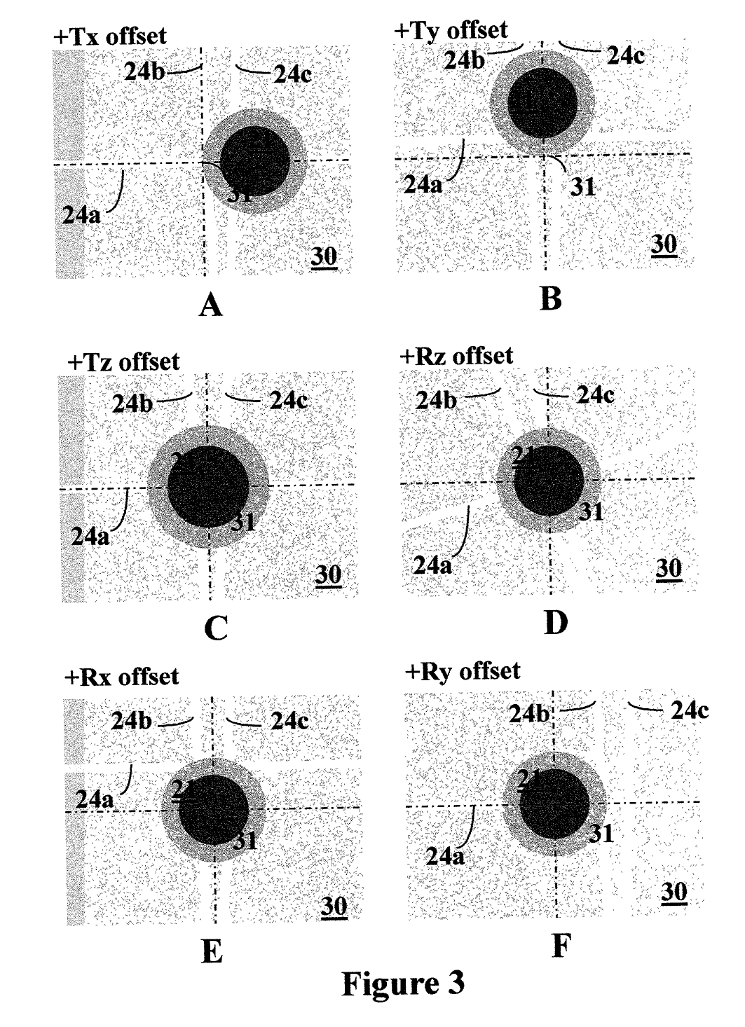

FIG. 3 shows camera image 30 when alignment target 11 is not perfectly aligned with camera 12, including an image 30 for each alignment error in translation (Tx, Ty, Tz) and an image 30 for each error in orientation (Rx, Ry, Rz). As shown, image 30 for each error is unique from the other images 30, enabling an operator to easily distinguish one error from another or combinations of many errors.

FIG. 3A shows camera image 30 when alignment target 11 has a positive X axes translation error (+Tx offset) with respect to image center 31. Spot 21 and strands 24b,c are located right of camera center 31 while the location of strand 26a remains symmetric about camera center 31, parallel to camera horizontal, and spot 21 is at the preset diameter.

FIG. 3B shows camera image 30 when alignment target 11 has a positive Y axes translation error (+Ty offset) with respect to image center 31. Spot 21 and strands 26a are located up from camera center 31 while the location of strand 24b,c remains symmetric about camera center 31, and strand 26a remains parallel to camera horizontal, and spot 21 is at the preset diameter.

FIG. 3C shows camera image 30 when alignment target 11 has a positive Z axes translation error (+Tz offset) with respect to image center 31. The diameter of Spot 21 is larger. Strands 26a-c remain symmetric about camera center 31, and strand 26a remains parallel to camera horizontal.

FIG. 3D shows camera image 30 when alignment target 11 has a positive Z axes orientation error (+Rz offset) with respect to image center 31. Strand 26a rotates from camera horizontal while spot 21 and strands 26a-c remain symmetric about camera center 31, and spot 21 is at the preset diameter.

FIG. 3E shows camera image 30 when alignment target 11 has a positive X axes orientation error (+Rx offset) with respect to image center 31. Strand 26a is located up from camera center 31 while the location of spot 21 and strands 24b,c remain symmetric about camera center 31, and strand 26a remains parallel to camera horizontal, and spot 21 is at the preset diameter.

FIG. 3F shows camera image 30 when alignment target 11 has a positive Y axes orientation error (+Ry offset) with respect to image center 31. Strand 24c-d are located right of camera center 31 while the locations of spot 21 and strands 26a remain symmetric about camera center 31, and strand 26a remains parallel to camera horizontal and spot 21 is at the preset diameter.

### Second Embodiment

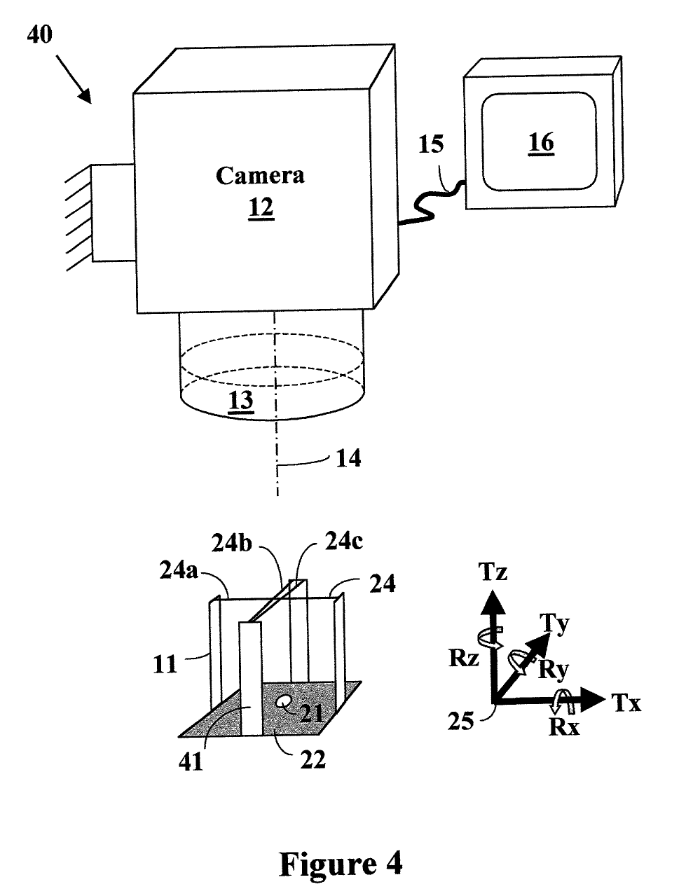

FIG. 4 shows the second embodiment 40 of Orientation and Position Sensor that includes all components of first embodiment 10 except alignment target 11 is modified such that spot 21 is mounted on base 22 and cross-hair 24 is mounted on posts 41.

### Third Embodiment

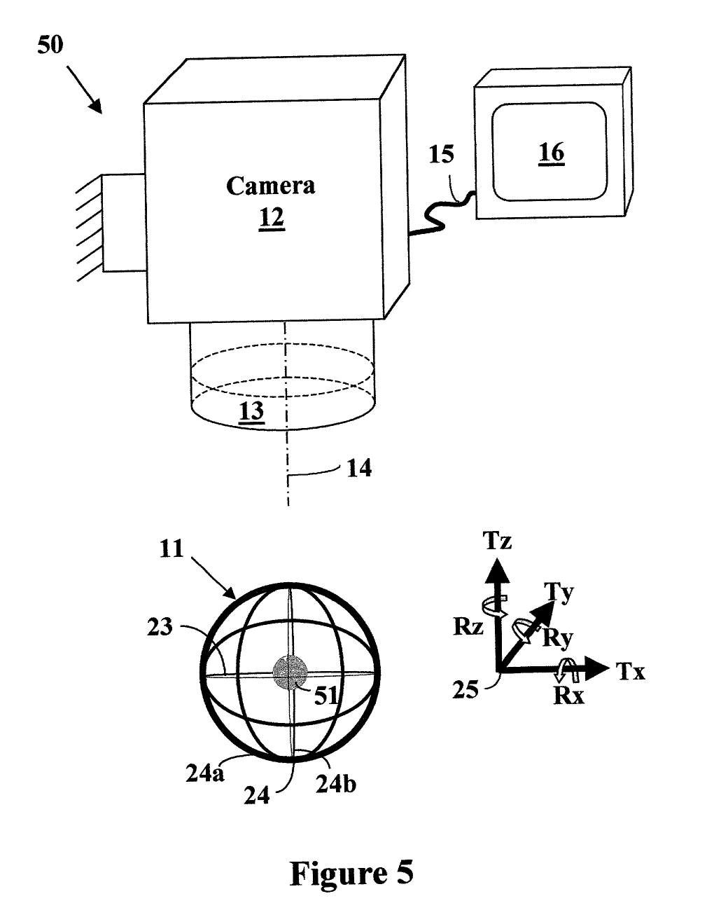

FIG. 5 shows the third embodiment 50 of Orientation and Position Sensor that includes all components of first embodiment 10 except alignment target 11 is modified such that spot 21 is replaced with sphere 51 and many cross-hairs 24 form a spherical frame about sphere 51. Transparent support 23 holds sphere 51 in the center of cross-hairs 24.

### Forth Embodiment

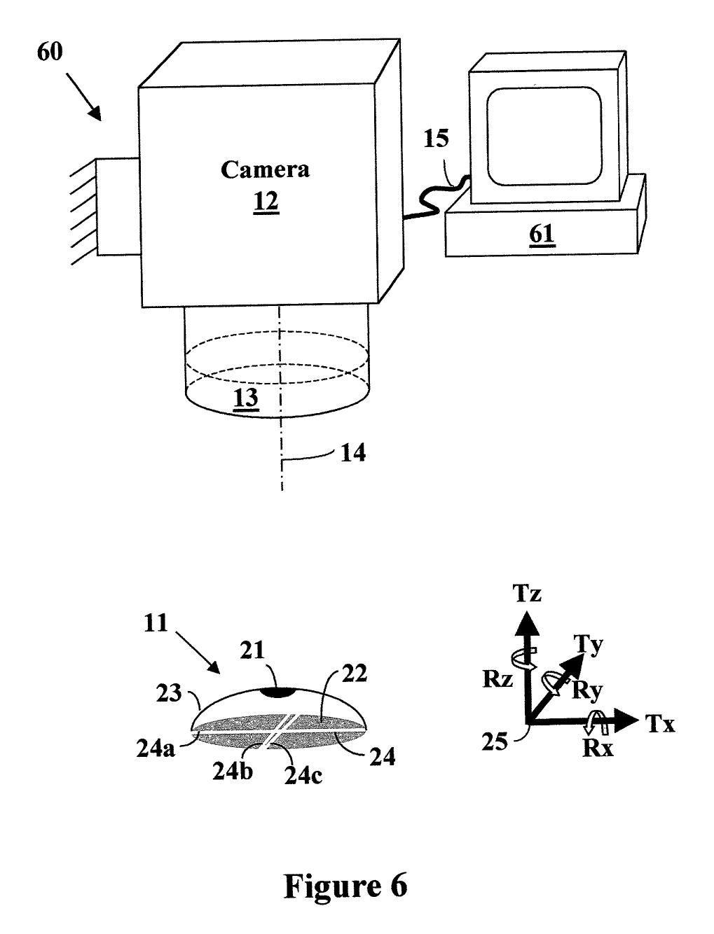

FIG. 6 shows the forth embodiment 60 of Orientation and Position Sensor that includes all components of first embodiment 10 except monitor 16 is replaced with computer 61. Software in computer 61 process images from camera 12 and interprets the position and orientation of alignment target 11 to camera 12.

### Advantages

The Orientation and Position Sensor is a substantial advance in the state of the art of multi-dimensional measurement sensors. Because of the small size of cameras, this sensor is extremely small. Because of the large number of pixels in most cameras, the resolution is high. Its simple design and low cost make it practical for many applications. The sensor is ideally suited for providing feedback for medical and industrial robots with many degrees of freedom, even up to the maximum of six. The number of other applications is large because it is so adaptable, compact, inexpensive, and easy to use.

### Conclusions, Ramifications, and Scope

This invention is capable of measuring variations in all positions and all orientations. The sensor is compact, accurate yet simple and inexpensive. This sensor will be of major benefit to automated machines such as robots functioning in all positions and orientations. Presently there are no robot sensors that provide feedback for more than three axis of operation, leaving three and often more axes without feedback. This lack of feedback is a major source of error and inefficiency. The Orientation and Position Sensor will be a practical and effective solution to this problem.

I claim:

1. A sensor for measuring position and orientation of an object, comprising:
a camera;
a lens;
a first feature of an alignment target;
a second feature of an alignment target;
whereby the relative position and size of the first feature and second feature in the camera image are interpreted to measure up to three orthogonal positions and up to three orthogonal orientations of said alignment target with respect to said camera.

2. The sensor of claim 1 further including a monitor.

3. The sensor of claim 1 further including a computer.
